(19) United States
(12) Patent Application Publication
(10) Pub. No.: US 2014/0300615 A1
(43) Pub. Date: Oct. 9, 2014

(54) MEMORY ACCESS CONTROLLER, DATA PROCESSING SYSTEM, AND METHOD FOR MANAGING DATA FLOW BETWEEN A MEMORY UNIT AND A PROCESSING UNIT

(71) Applicants: Michael Staudenmaier, Munich (DE); Vincent Aubineau, Gif Sur Yvette (FR); Juergen Frank, Munich (DE)

(72) Inventors: Michael Staudenmaier, Munich (DE); Vincent Aubineau, Gif Sur Yvette (FR); Juergen Frank, Munich (DE)

(73) Assignee: FREESCALE SEMICONDUCTOR, INC., Austin, TX (US)

(21) Appl. No.: 14/358,051

(22) PCT Filed: Nov. 24, 2011
(86) PCT No.: PCT/IB2011/003199

§ 371 Date: May 14, 2014

(51) Int. Cl. G09G 5/395; G09G 5/36

(52) U.S. Cl. CPC G09G 5/395; G09G 5/363; G09G 2360/10
USPC 345/531

(57) ABSTRACT

A memory access controller for managing data flow between a memory unit and a processing unit is described. The memory access controller comprises an addressing unit and an unpacking unit. The addressing unit may receive an address from said processing unit and select a data location within said memory unit in dependence on that address. The unpacking unit may read a first word from the selected data location, unpack the first word into a second word by applying a data conversion scheme which depends on the received address, and provide the second word to the processing unit. The data conversion scheme may comprise, for at least one possible address, a pixel format conversion. A data processing system and a method are also proposed.

### FIELD OF THE INVENTION

This invention relates to a memory access controller, a data processing system, and a method for managing data flow between a memory unit and processing unit.

### BACKGROUND OF THE INVENTION

Digital image processing systems usually comprise a processor for processing image data and a memory for storing image data. The processor may comprise one or more processing cores. For example, the processor may be operated to generate new image data and to store the newly generated data in the memory. The processor may likewise be operated to fetch image data from the memory unit and process it, for instance, to generate modified graphical content in a format suitable for a display controller

The image data processed by the processor and the image data residing in the memory unit may have different formats or be based on different representations. For example, the image data in the memory unit may comprise pixel data in a first pixel format, and the processor may be arranged to execute pixel processing operations based on a different second pixel format. For example, a variety of red green blue alpha (RGBA) formats are known in the art. Furthermore, a pixel state may be described using different representations which may be based, for example, on different color spaces. RGB and YUV are examples of different representations. The processor may therefore be arranged to perform data conversions. Data conversion may include pixel format conversion, or representation conversion (e.g. color space mapping), or a combination thereof.

Both format conversions and representation conversions may be implemented in software. For instance, pixel format conversion instructions may be read by a processor core to perform the desired conversions. Software implemented format conversions may, however, represent quite a substantial additional effort for the processor and may slow down the image processing.

Pixel format conversion may be sped up by means of a dedicated pixel format conversion stage which may be interfaced between the main processor and the memory unit. The pixel format may thus be converted when sending pixel data to or when fetching pixel data from the memory unit, thereby relieving the processor. The processor's computing power may thus be used more efficiently for those image processing tasks for which no dedicated hardware is at hand.

U.S. Pat. No. 6,452,601 B1 by Marino et al. describes a computer system which comprises a graphics adapter for assembling, disassembling, and sometimes modifying pixel data as they are transferred from a system to a display device, system to system, or display device to system. The graphics adapter may, for example, transform 8 bit host data into 32 bit frame buffer data suitable for storage in a frame buffer.

Donovan et al. describes an inexpensive pixel processor, the SX, implemented in a memory controller for a work station (W. Donovan et al., “Pixel processing in a memory controller”, IEEE Computer Graphics and Applications, page 51-61, 1995). The SX supports various data formats such as 8 bit, 16 bi, and 32 bit pixel formats.

### SUMMARY OF THE INVENTION

The present invention provides a memory access controller, a data processing system, and a method as described in the accompanying claims.

Specific embodiments of the invention are set forth in the dependent claims.

These and other aspects of the invention will be apparent from and elucidated with reference to the embodiments described hereinafter.

### BRIEF DESCRIPTION OF THE DRAWINGS

Further details, aspects and embodiments of the invention will be described, by way of example only, with reference to the drawings. In the drawings, like reference numbers are used to identify like or functionally similar elements. Elements in the figures are illustrated for simplicity and clarity and have not necessarily been drawn to scale.

FIG. 1 schematically shows an example of an embodiment of a data processing system.

FIG. 2 shows a flow chart of an example of an embodiment of a data conversion method.

FIG. 3 shows a flow chart of an example of an embodiment of a data back conversion method.

FIGS. 4 to 7 each show a schematic representation of an example of an embodiment of a data conversion scheme.

FIG. 8 schematically shows an example of an embodiment of a data back conversion scheme.

### DETAILED DESCRIPTION OF THE PREFERRED EMBODIMENTS

Because the illustrated embodiments of the present invention may for the most part, be implemented using electronic components and circuits known to those skilled in the art, details will not be explained in any greater extent than that considered necessary as illustrated above, for the understanding and appreciation of the underlying concepts of the present invention and in order not to obfuscate or distract from the teachings of the present invention.

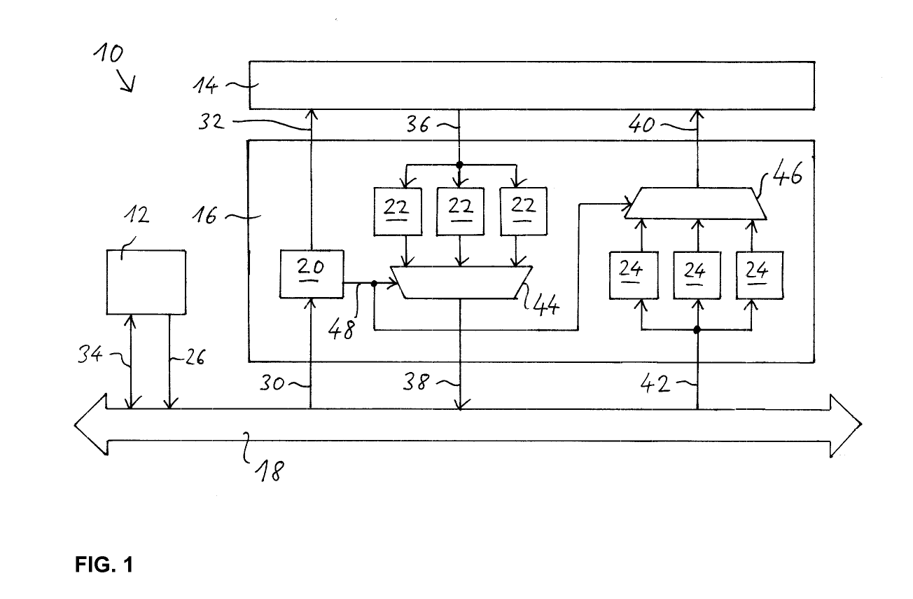

FIG. 1 schematically shows an example of a data processing system 10. The data processing system 10 may, for example, be part of a personal computer, a workstation, automobile equipment, a mobile phone, a personal media player, or a navigation system. The data processing system 10 may notably comprise a processing unit 12, a memory unit 14, and a memory access controller 16. The memory access controller 16 may be connected between the memory unit 14 and the processing unit 12 and arranged to manage data flow between the memory unit 14 and the processing unit 12. The processing unit 12 may, for example, be or comprise a general purpose processor, a Direct-Memory-Access (DMA) controller, a graphics processing unit (GPU), a display controller, an image decoder, or an image encoder.

The memory access controller 16 may comprise an addressing unit 20 and an unpacking unit 22, 44. The addressing unit 20 may be arranged to receive an address from the processing unit 12 and to select a data location within the memory unit 14 in dependence on the received address. The unpacking unit 22, 44 may be arranged to read a first word from the selected data location, to unpack this first word into a second word by applying a data conversion scheme which depends on the received address, and to provide this second word to the processing unit 12. Different data conversion schemes may thus be integrated in the memory access controller 16. For instance, at least one address may have associated with it a data conversion scheme that comprises a pixel format conversion.

In this context, a word is a sequence of data bits comprising a fixed number of bits. The number of bits in one word is referred to as the word size. A word may, for example, consist of 8, 16, or 32 bits. The aforementioned first word read from the memory unit 14 by the unpacking unit 22, 44 may, for example, comprise 16 bits, whereas the word delivered by the unpacking unit 22, 44 may comprise, for example, 32 bits. The memory access unit 16 may thus be used, for example, as a word size adapter between a memory unit (memory unit 14 in the shown example) from which data may be retrieved in words having a first word size and a client (processing unit 12 in the shown example) capable of processing data in blocks having a different second word size. For example, the second word mentioned above may be larger than the first word. The integration of word size adaptation in a memory access controller may be very beneficial in a variety of architectures in which a client (e.g., processing unit 12) having registers of a second word size is to exchange data with a data storage unit (e.g., memory unit 14) that has memory segments of a different first word size. For instance, general purpose cores with single-instruction multiple-data (SIMD) may support only generic data layout in memory.

However, the first word size and the second word size are not necessarily different. The unpacking unit 22, 44 may, for example, be arranged to unpack a first word read from the memory unit 14 into a second word having the same size as the first word. In another example, the first word may be larger than the second word.

In the example, the data processing system 10 may comprise a bus 18 for transferring data between units connected to the bus. In the example, the processing unit 12 may be connected to the bus 18 via, for example, a signal line 26 for sending memory access signals to the bus 18. A memory access signal may notably include a memory address for specifying a data location in the memory. The memory access signal may further include a data length specification for specifying the length of the data to be accessed. The memory access signal may further include access type specification for indicating whether the data is to be read from or written to the memory unit 14. It is noted that the memory unit 14 may be read-only.

The processing unit 12 may further be connected to the bus 18 via a data line 34 for transferring data between, e.g., a data cache of the processing unit 12 and the bus 18. The processing unit 12 may, for instance, be a central processing unit comprising one or more processing cores. For example, the processing unit 12 may be a general purpose processor.

The addressing unit 20 may be connected to the bus 18 via a signal line 30. The signal line 30 may be arranged to transfer memory access signals such as read or write requests issued by the processing unit 12 to the addressing unit 20. The memory unit 14 may be connected to the addressing unit 20 via a signal line 32. The signal line 32 may be arranged to transmit memory access information to the memory unit 14. The memory access information may notably comprise, for each memory access request from the processing unit 12, an address indicating a data location within the memory unit 14. The address indicated by the addressing unit 20 via the signal line 32 may notably be a physical address generated on the basis of a virtual address received via the signal line 30. In other words, the addressing unit 20 may be arranged to select data locations in the memory 14 from which data is to be read or to which data is to be written.

The unpacking unit 22, 44 may be connected to the memory unit 14 via a data line 36. The unpacking unit 22, 44 may further be connected to the bus 18 via a data line 38. In the shown example, the unpacking unit 22, 44 may comprise at least two different unpacking modules and a selection unit 44. In the shown example, the unpacking unit 22, 44 comprises three different unpacking modules 22. The unpacking modules 22 may be connected in parallel between the memory unit 14 and the selection unit 44. Each unpacking module 22 may provide a different data conversion scheme. Thus, each unpacking module 22 may transform a first word retrieved from the selected data location in the memory unit 14 into a second word which is provided to the selection unit 44. At least one of the data conversion schemes provided by the unpacking modules 22 may, for example, comprise a pixel format conversion.

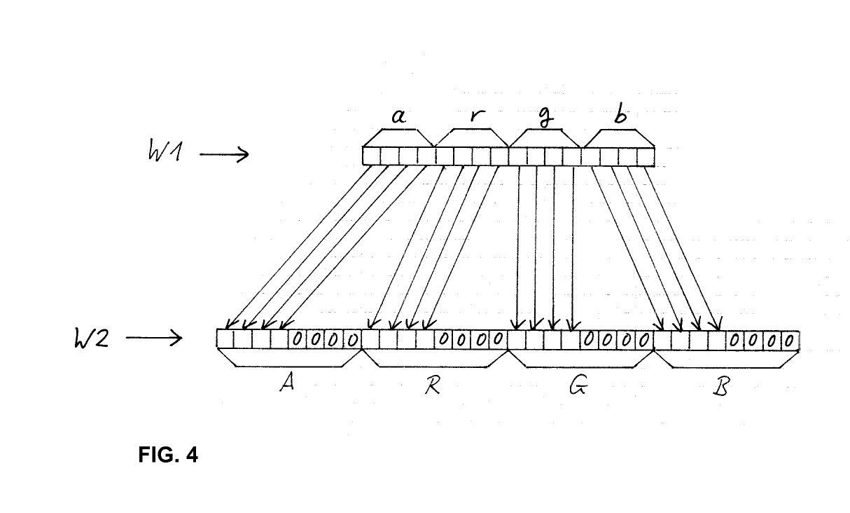

For instance, a first unpacking module 22 may apply an identity operation on the first word, i.e., this first unpacking module 22 may output as, a second word, the first word, in which case the first word and the second word are identical. A second one of the unpacking modules 22 may, for instance, provide a first pixel format conversion, while a third unpacking unit 22 may provide a different second pixel format conversion. Examples of different pixel format conversions are described further below in reference to FIGS. 4 to 7.

In general terms, any kind of data conversion may, at least in principle, be implemented by a suitable unpacking module 22. The unpacking modules 22 may be hardware or software modules.

In the shown example, they are hardware modules wherein each unpacking module 22 may be dedicated circuitry connected to the selection unit 44. The selection unit 44 may, for example, be a multiplexer unit implemented in hardware. The selection unit 44 may be arranged to output as the aforementioned second word a selected one of the words output by the unpacking modules 22. In the shown example, the selection unit 44 is connected to the addressing unit 20 via a control line 48. The control line 48 may be arranged to send address information or conversion mode information from the addressing unit 20 to the selection unit 44. The conversion mode information may be aggregated from the address information. The selection unit 44 may be arranged to select one of the unpacking modules 22 in dependence on this address information. The address information may, for example, include at least parts of the virtual address (as issued by the processing device 12 and received by the addressing unit 20 via the signal lines 26 and 30) or at least parts of the physical address determined by the addressing unit 20 on the basis of the virtual address. The selection unit 44 may thus select an appropriate unpacking module 22 and thus an appropriate data conversion scheme in dependence on the data location that is addressed in the memory unit 14.

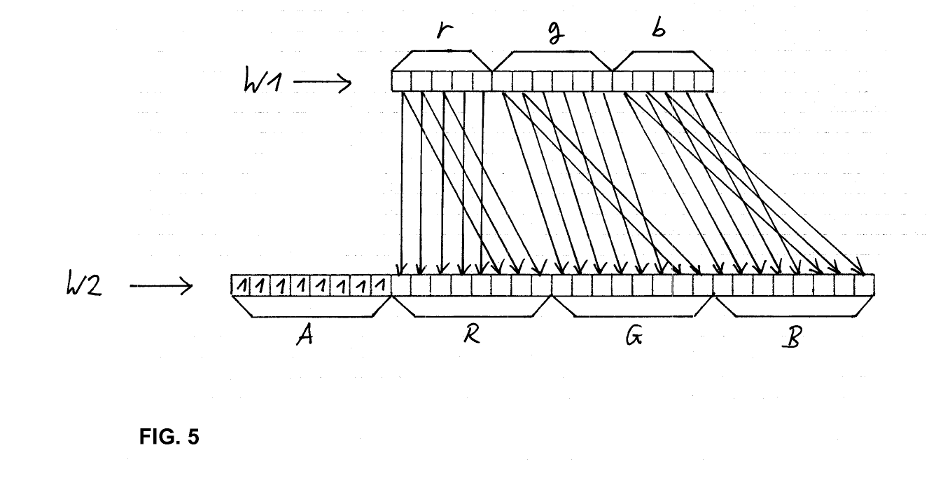

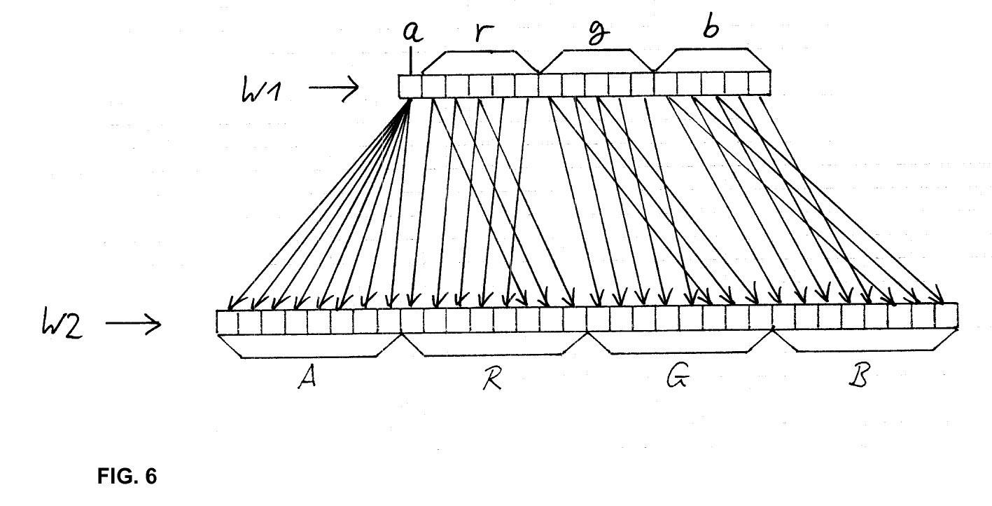

For instance, the virtual address indicated by the processing unit 12 may comprise a page number and an offset, the page number indicating a specific region in the memory unit 14 and the offset indicating a data location in that region. In the shown example, the memory unit 14 may, for example, comprise several memory regions, each memory region being associated with one of the unpacking modules 22 and thus with one of the different data conversion schemes. Each memory region may, for example, contain pixel data in a specific pixel format. For example, a first memory region may contain pixel data in the ARGB 4444 format (see FIG. 4), a second memory region may contain pixel data in the RGB 565 format (see FIG. 5), while a third memory region may contain pixel data in the ARGB 1555 format (see FIG. 6). The selection unit 44 may accordingly be arranged to select the appropriate unpacking module 22 in dependence on only the page number, but not on the offset of the virtual address indicated by the addressing unit 20. In this example, the data conversion scheme thus depends on the page number but not on the offset.

In a related example, the same memory region may be accessed using different format conversions. For example, a region of the memory unit 14 may be connected to two or more unpacking modules 22, or to two or more packing modules 24. For instance, it may be possible e.g.

to write a memory area in the memory unit 14 with no conversion and later use it with the ARGB4444 to ARGB8888 conversion. Furthermore, memory regions in the memory unit 14 may be overlapping. For example, the whole memory provided by the memory unit 14 may be mapped to several address regions each with a different conversion scheme. One of the address regions may, for example, be transparent.

The addressing unit 20 may be arranged to map virtual addresses received from, e.g., the processing unit 12 into physical addresses of data segments in the memory unit 14. This mapping may, for example, involve the use of one or more lookup tables stored in the addressing unit 20 or elsewhere. The mapping may also involve arithmetic operations, for example if a data format expected by the processing unit 12 and data segments of the memory unit 14 are not identical in size. For instance, in a scenario in which the processing unit 12 has a word size of 32 bits and pixels are stored in the memory unit 14 using a 16 bit format, the mapping may involve dividing a virtual address number by a factor of two. The processor may further be arranged to apply some additional formating. The memory access controller 16 may further comprise a packing unit 24, 46 for converting data words received from the processing unit 12 into data words suitable for storage in the memory unit 14. The packing unit 24, 46 may be largely analogous in design to the unpacking unit 22, 44 but arranged for back conversion during write operations. The packing unit 24, 26 may thus comprise, for example, one or more packing modules 24, each packing module 24 arranged to provide a distinct data back conversion scheme.

The packing unit 24, 46 may further comprise a selection unit 46 arranged to select a specific packing module 24 if there are more than one packing modules 24. The selection unit 46 of the packing unit 24, 46 may be controlled by the addressing unit 20 in a manner similar to the control of the selection unit 44 described above. The selection unit 46 may thus, for instance, select a specific packing module 24 in dependence on a page number of a virtual address indicated by the processing unit 12. The address received from the processing unit may for example comprise a page number and an offset, the data back-conversion scheme depending on the page number but not on said offset. It is also noted that there may be at least one address having associated with it a data back conversion scheme that comprises a pixel format back-conversion. In practice, a plurality of addresses may be associated with a particular conversion scheme. Furthermore, the same plurality of addresses may be associated with a particular back conversion scheme.

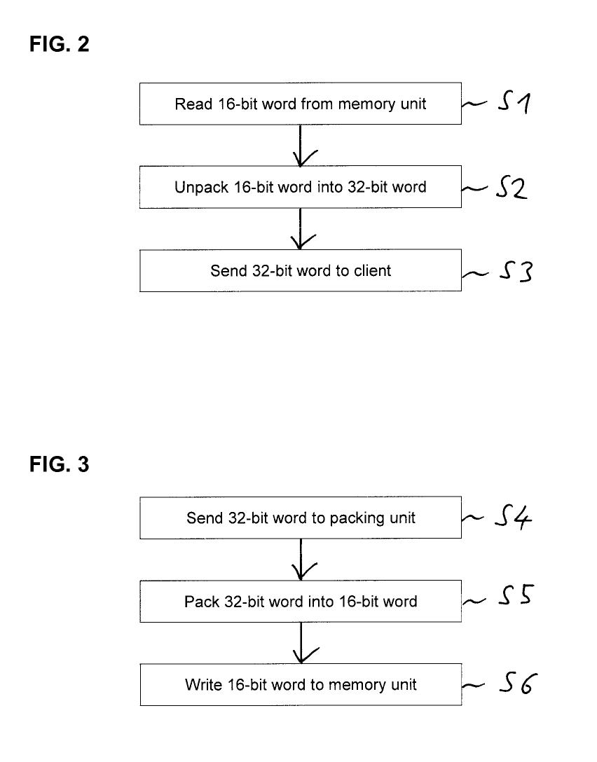

In an alternative design, the selection units, e.g. the selections units 44 or 46 or both, are not controlled via the addressing unit 20 but instead via control lines connected to the bus 18 bypassing the addressing unit 20. In an example scenario, the memory access controller 16 may operate as described below with additional reference to FIGS. 2 and 3. FIG. 2 illustrates an example of a read operation in which a data word is retrieved from the memory unit 14, while FIG. 3 represents an example of a write operation in which a data word is loaded to the memory unit 14.

For instance, the unpacking unit 22, 44 may read a first word from the memory unit 14 (block S1), unpack this first word into a second word (block S2), and then send this second word to the processing unit 12 via, e.g., the bus 18 (block S3). The first word and the second word may, for example, be a sequence of 16 bits and a sequence of 32 bits, respectively. These word sizes may occur, for instance, if the processing device 12 is a general purpose 32-bit processing device, whereas the memory unit 14 does not allow reading or writing more than 16 bits in parallel. In another scenario, the memory unit 14 comprises a plurality of 32-bit memory cells, with two 16-bit pixel state identifiers stored in each memory cell.

The block S2 of unpacking the first word into the second word may comprise selecting an appropriate unpacking module 22, for instance, in dependence on the data location at which the first word is stored in the memory unit 14 or in dependence on some related characteristic, such as a virtual or physical address specifying that data location or a page number specifying a memory region which contains the respective data location.

Blocks S1, S2, and S3 may be repeated for a plurality of different data locations in the memory unit 14, for example, to retrieve a digital image from the memory unit 14. For example, the first word may contain pixel state information representing one or more pixel states. A pixel state is a physical state of a pixel and may be characterized by parameters such as color, brightness, transparency or other characteristics. For instance, the first word may contain exactly one pixel state identifier in a 16 bit format. In block S2, the 16 bit pixel format may be converted into a 32 bit pixel format, for example. Alternatively, the first word may comprise a group of pixel state identifiers. For instance, the first word may contain 32 bits for indicating two pixel states, each pixel state being represented by 16 bits. The composition of two 16 bit pixel state identifiers may then be converted into a corresponding composition of two 32 bit pixel state identifiers. More than two pixel state identifiers, e.g. three or four, may be included in a single word, depending on the size of the pixel state identifiers and on the size of the word. In a more general example, the unpacking unit may unpack a group of at least two words in parallel, each word of the group having the size of the first word. Similarly, the packing unit may pack a group of at least two words in parallel, each word of the group having the size of the third word. The group of unpacked words may further be transferred in parallel via the bus 18 and processed by the processing unit 12.

The operation of loading and converting a group of pixel state identifiers in parallel may be described alternatively but equivalently as an operation in which a group of words is loaded from the memory unit 14 in parallel and unpacked in parallel, e.g., by one of the unpacking modules 22. A group of first words may thus be loaded and converted in parallel into a corresponding second group of words. The group of first words may for example comprise two, three, four, or more than four words. Similarly, the group of second words may comprise two, three, four, or more than four words. The words in the first group may each have a first word size, e.g., 16 bits, and the words in the second group may each have a second word size, e.g., 32 bits. Word sizes different from the example word sizes described here may of course be envisioned.

Referring now to FIG. 3, the packing unit 24, 46 may receive a third word from the processing unit, pack said third word into a fourth word by applying a data back-conversion scheme which depends on the received address, and write the fourth word to the selected memory location.

For example, the processing device 12 may send a third word to the packing unit 24, 46 (block S4). The packing unit may pack the third word into a fourth word (block S5) and load the fourth word to the memory unit 14 (block S6). The third word and the fourth word may, for example, contain 32 bits and 16 bits, respectively. The first word, i.e., a word read from the memory unit 14, and the fourth word, i.e., a word written to the memory unit 14, may notably have the same size, i.e., comprise the same number of bits. Similarly, the second word, i.e., a word received by the processing unit 12, and the third word, i.e., a word sent by the processing unit 12, may have the same size. The third word and the fourth word may each comprise, for example, a single pixel state identifier or group of pixel state identifiers in a manner analogous to the first and second word described above in reference to FIG. 2. Furthermore, the packing unit 24, 46 may be arranged to process a group of words in parallel, similar to the parallel processing of words by the packing unit 22, 44. The group of words may for example contain two, three or four words.

The data back-conversion may, for example, be an inverse of the data conversion. Each unpacking module 22 in the unpacking unit 22, 44 may for example have a counterpart packing module 24 in the packing unit 24, 46, the counterpart packing module 24 being arranged to perform a data back-conversion which is an inverse of the data conversion provided by the corresponding packing module 22 in the sense that converting and then back converting an input word returns the same input word. In other words, unpacking a word, then packing the unpacked word may yield the original packed word. However, packing a word, then unpacking the packed word may generally yield a word different from the original word due to loss of information in the packing operation. The loss of information may however be acceptable for the specific use case. For example, the loss of information may involve only one or more less significant bits of, for instance, a color intensity value.

Blocks S4, S5 and S6 may be performed repeatedly for a plurality of data locations of the memory unit 14, for example, to load a digital image to the memory unit 14.

FIG. 4 illustrates an example of a first word W1, a second word W2 and a data conversion for converting the first word W1 into the second word W2. In the example, the first word W1 is a sequence of 16 bits while the second word W2 is a sequence of 32 bits. The first word W1 may, for example, describe a pixel state using the ARGB 4444 format. In this format, a first group of bits (bits 1 to 4) may represent a transparency level, also referred to as alpha. A second group of bits (e.g., bits 5 to 8) may indicate an intensity of a red color component. A third group of bits (e.g., bits 9 to 12) may indicate an intensity of a green color component. A fourth group of bits (e.g., bits 13 to 16) may indicate an intensity of a blue color component.

The second word W2 may represent a pixel state using the ARGB 8888 format. This format differs from the described ARGB 4444 format only in that each of the four groups of bits comprises a total of 8 rather than 4 bits. Accordingly, bits 1 to 8, 9 to 16, 17 to 24, and 25 to 32 may indicate a transparency level, a red color intensity, a green color intensity, and a blue color intensity, respectively.

The data conversion scheme provided by one of the unpacking modules 22 may copy each group of bits of the first word W1, i.e., groups “a”, “r”, “g”, and “b”, into the corresponding group of the second word W2 as indicated by the arrows. For example, bits 1 to 4 of the first word W1 may be copied into bits 1 to 4 of the second word W2. Bits 5 to 8 of the second word W2 may be set to zero. In this figure, the leftmost bits of each group in the first word W1 and in the second word W2, respectively, may represent the most significant bits of the respective groups. Bits 1, 9, 17, and 25 of the second word W2 may thus be the most significant bits (MSB) of the alpha, red, green, and blue groups of the second word W2, respectively.

FIG. 5 illustrates another example of a first word W1 and a second word W2. The first word W1 and the second word W2 may represent a pixel state using the format RGB 565 and ARGB 8888, respectively. In this example, the first word W1 does not contain transparency information. The alpha group (bits 1 to 8 of second word W2) may therefore be set, for example, to the highest possible value, which in this case is the binary number 11111111. This number may, for instance, be interpreted as “fully opaque”.

The shown example further diverts from the one of FIG. 4 in that a number of least significant bits in each group of bits in the second word W2 may be filled with the values of a corresponding number of leading bits of the corresponding group of bits in the first word W1. It may thus be ensured that the lowest possible value of each group in the first word W1 is transformed into the lowest possible value of the corresponding group in the second word W2. For instance, the minimum value 0000 and the maximum value 11111 of the blue group of the first word W1 may thus be mapped into the minimum value 00000000 and into the maximum value 11111111 of the blue group of the second word W2, respectively.

FIG. 6 further illustrates an example of a transformation from the format ARGB 1555 to the format ARGB 8888. In this example, the first word W1 comprises a single bit for representing the alpha index, whereas the second word W2 may contain 8 bits reserved for the alpha index. The alpha bit of the first word W1 may be copied to each of the bits of the alpha group of the second word W2. In other words, bit 1 of the first word W1 may be copied to each of bits 1 to 8 of the second word W2.

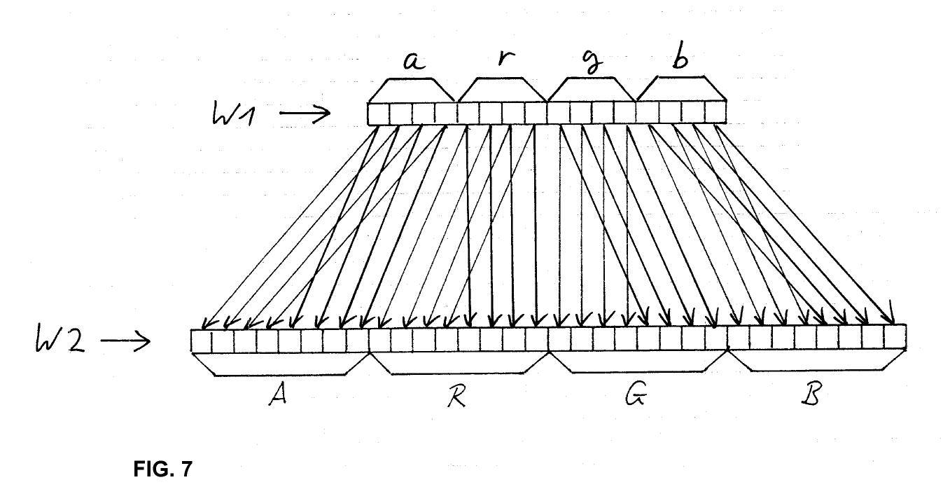

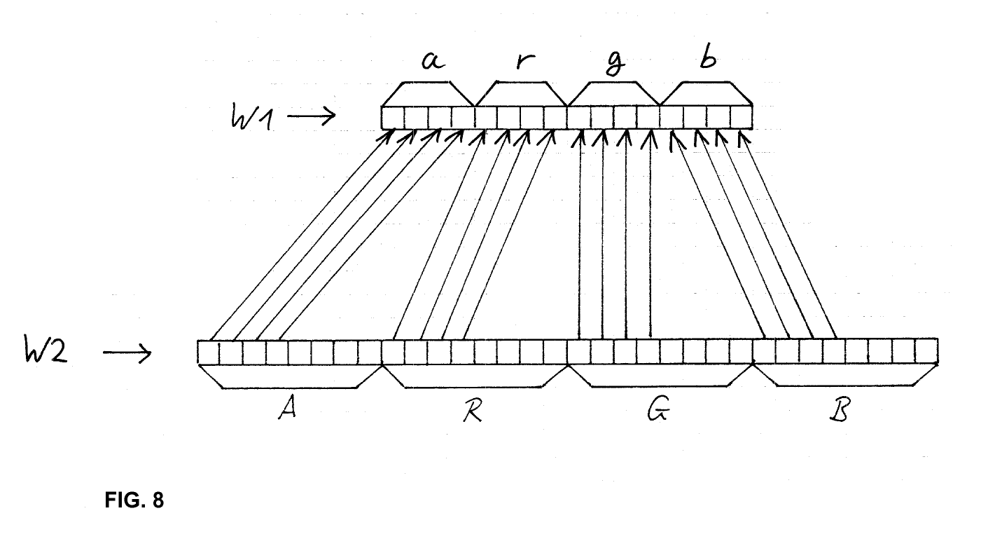

FIG. 7 further illustrates an example of a format conversion from ARGB 4444 to ARGB 8888.

FIG. 8 finally illustrates an example of a back conversion from ARGB 8888 to ARGB 4444. In this example, the four least significant bits of each group (i.e., the alpha group, the red group, the green group, and the blue group) are lost in the transformation. The back transformation may therefore involve a loss of information. The shown back transformation is, however, the inverse of both the forward transformation shown FIG. 4 and the forward transformation shown in FIG. 7.

Other pixel format conversion schemes may be envisioned. Such schemes may, for instance, involve arithmetic operations such as rounding, truncating, padding, dithering, or one or more color space conversions. It is noted that color space conversions may be fairly complex. Each or at least one of the unpacking and packing modules 22, 24 may comprise dedicated circuitry for performing a color space conversion. A significant gain in computational speed may thereby be achieved. This dedicated circuitry may for example be non-programmable logical circuitry. Although the FIGS. 4 to 8 only show a single pixel state identifier per word, a single word may comprise several word pixel state identifiers. For instance, the first word W1 may comprise two pixel state identifiers, each pixel state identifier comprising, for instance, 16 bits using, for example, the ARGB 4444 format as shown in FIGS. 4 and 8. The second word may accordingly comprise two pixel format identifiers, each pixel state identifier having the ARGB 8888 format, for example. Word sizes larger than 32 and 64 bits may be envisioned.

In the foregoing specification, the invention has been described with reference to specific examples of embodiments of the invention. It will, however, be evident that various modifications and changes may be made therein without departing from the broader spirit and scope of the invention as set forth in the appended claims. The terms “front,” “back,” “top,” “bottom,” “over,” “under” and the like in the description and in the claims, if any, are used for descriptive purposes and not necessarily for describing permanent relative positions. It is understood that the terms so used are interchangeable under appropriate circumstances such that the embodiments of the invention described herein are, for example, capable of operation in other orientations than those illustrated or otherwise described herein. The connections as discussed herein may be any type of connection suitable to transfer signals from or to the respective nodes, units or devices, for example via intermediate devices. Accordingly, unless implied or stated otherwise, the connections may for example be direct connections or indirect connections. The connections may be illustrated or described in reference to being a single connection, a plurality of connections, unidirectional connections, or bidirectional connections. However, different embodiments may vary the implementation of the connections. For example, separate unidirectional connections may be used rather than bidirectional connections and vice versa. Also, a plurality of connections may be replaced with a single connection that transfers multiple signals serially or in a time multiplexed manner. Likewise, single connections carrying multiple signals may be separated out into various different connections carrying subsets of these signals. Therefore, many options exist for transferring signals.

Although specific conductivity types or polarity of potentials have been described in the examples, it will be appreciated that conductivity types and polarities of potentials may be reversed.

Each signal described herein may be designed as positive or negative logic. In the case of a negative logic signal, the signal is active low where the logically true state corresponds to a logic level zero. In the case of a positive logic signal, the signal is active high where the logically true state corresponds to a logic level one. Note that any of the signals described herein can be designed as either negative or positive logic signals. Therefore, in alternate embodiments, those signals described as positive logic signals may be implemented as negative logic signals, and those signals described as negative logic signals may be implemented as positive logic signals. Furthermore, the terms “assert” or “set” and “negate” (or “deassert” or “clear”) are used herein when referring to the rendering of a signal, status bit, or similar apparatus into its logically true or logically false state, respectively. If the logically true state is a logic level one, the logically false state is a logic level zero. And if the logically true state is a logic level zero, the logically false state is a logic level one. Any arrangement of components to achieve the same functionality is effectively “associated” such that the desired functionality is achieved. Hence, any two components herein combined to achieve a particular functionality can be seen as “associated with” each other such that the desired functionality is achieved, irrespective of architectures or intermedial components. Likewise, any two components so associated can also be viewed as being “operably connected,” or “operably coupled,” to each other to achieve the desired functionality.

Furthermore, those skilled in the art will recognize that boundaries between the above described operations merely illustrative. The multiple operations may be combined into a single operation, a single operation may be distributed in additional operations and operations may be executed at least partially overlapping in time. Moreover, alternative embodiments may include multiple instances of a particular operation, and the order of operations may be altered in various other embodiments.

Also for example, in one embodiment, the illustrated examples may be implemented as circuitry located on a single integrated circuit or within a same device. For example, units 12, 14, and 16 may be located within a same device. Alternatively, the examples may be implemented as any number of separate integrated circuits or separate devices interconnected with each other in a suitable manner. For example, units 12, 14, and 16 may be separate devices interconnected via external data lines.

Also for example, the examples, or portions thereof, may implemented as soft or code representations of physical circuitry or of logical representations convertible into physical circuitry, such as in a hardware description language of any appropriate type.

However, other modifications, variations and alternatives are also possible. The specifications and drawings are, accordingly, to be regarded in an illustrative rather than in a restrictive sense.

In the claims, any reference signs placed between parentheses shall not be construed as limiting the claim. The word ‘comprising’ does not exclude the presence of other elements or steps then those listed in a claim. Furthermore, the terms “a” or “an,” as used herein, are defined as one or more than one. Also, the use of introductory phrases such as “at least one” and “one or more” in the claims should not be construed to imply that the introduction of another claim element by the indefinite articles “a” or “an” limits any particular claim containing such introduced claim element to inventions containing only one such element, even when the same claim includes the introductory phrases “one or more” or “at least one” and indefinite articles such as “a” or “an.” The same holds true for the use of definite articles. Unless stated otherwise, terms such as “first” and “second” are used to arbitrarily distinguish between the elements such terms describe. Thus, these terms are not necessarily intended to indicate temporal or other prioritization of such elements. The mere fact that certain measures are recited in mutually different claims does not indicate that a combination of these measures cannot be used to advantage.

1. A memory access controller for managing data flow between a memory unit and a processing unit, said memory access controller comprising an addressing unit and an unpacking unit,
said addressing unit being arranged to receive an address from said processing unit and to select a data location within said memory unit in dependence on said address,
said unpacking unit being arranged to read a first word from said selected data location, to unpack said first word into a second word by applying a data conversion scheme which depends on said address, and to provide said second word to said processing unit.

2. The memory access controller of claim 1, said second word being larger than said first word.

3. The memory access controller of claim 1, said data conversion scheme comprising, for at least one possible address, a pixel format conversion.

4. The memory access controller of claim 1, said address received from said processing unit comprising a page number and an offset, said data conversion scheme depending on said page number but not on said offset.

5. The memory access controller of claim 1, said unpacking unit being arranged to unpack a group of at least two words in parallel, each word of the group having the size of said first word.

6. The memory access controller of claim 1, further comprising a packing unit arranged to receive a third word from said processing unit, to pack said third word into a fourth word by applying a data back-conversion scheme which depends on said received address, and to write said fourth word to said selected memory location.

7. The memory access controller of claim 6, said data back-conversion being an inverse of said data conversion.

8. The memory access controller of claim 6, said data back-conversion scheme comprising, for at least one possible address, a pixel format back-conversion.

9. The memory access controller of claim 6, said address received from said processing unit comprising a page number and an offset, said data back-conversion scheme depending on said page number but not on said offset.

10. The memory access controller of claim 6, said packing unit being arranged to pack a group of at least two words in parallel, each word of the group having the size of said third word.

11. A data processing system comprising a memory unit, a processing unit, and a memory access controller, said memory access controller being connected between said memory unit and said processing unit and arranged to manage data flow between said memory unit and said processing unit, said memory access controller comprising an addressing unit and an unpacking unit,
said addressing unit being arranged to receive an address from said processing unit and to select a data location within said memory unit in dependence on said address,
said unpacking unit being arranged to read a first word from said selected data location, to unpack said first word into a second word by applying a data conversion scheme which depends on said address, and to provide said second word to said processing unit.

12. The data processing system of claim 11, said unpacking unit being arranged to unpack a group of at least two words in parallel, each word of the group having the size of said first word, said processing unit being arranged to process the group of unpacked words in parallel.

13. The data processing system of claim 12, said processing unit being connected to said memory access controller via a bus, said bus being arranged to transfer the group of unpacked words in parallel.

14. The data processing system of claim 11, or said processing unit being a general purpose processor, a Direct-Memory-Access controller, a graphics processing unit, a display controller, an image decoder, or an image encoder.

15. A method for managing data flow between a memory unit and a processing unit, comprising:
receiving an address from said processing unit;
selecting a data location within said memory unit in dependence on said address;
reading a first word from said selected data location;
unpacking said first word into a second word by applying a data conversion scheme which depends on said address; and
providing said second word to said processing unit.
